(19) United States
(12) Patent Application Publication
(10) Pub. No.: US 2007/0051468 A1
(43) Pub. Date: Mar. 8, 2007

(54) Process for manufacturing a laminate

(76) Inventor: Hans-Rudolf Nageli, Neuhausen (CH)

Correspondence Address: FISHER, CHRISTEN & SABOL, 1725 K STREET, N.W., SUITE 1108, WASHINGTON, DC, 20006, US

(21) Appl. No.: 11/511,299

(22) Filed: Aug. 29, 2006

(30) Foreign Application Priority Data
Sep. 7, 2005 (EP) 05405524.9

(51) Int. Cl. C09J 101/00

(52) U.S. Cl. 156/331.7

(57) ABSTRACT

A process for manufacturing a laminate (48) made up of two film-shaped substrates (44, 46) joined together by a layer of adhesive is such that a first substrate (44) is coated with a multi-layer liquid film comprising at least two adhesive layers (34, 38) by liquid film coating using curtain coating or slide coating, and subsequently bonded to a second substrate (46). The process makes it possible, in a simple and cost-favourable manner, to bond different substrates using adhesive layers that suit the specific surfaces

The invention relates to a process for manufacturing a laminate made up of two film-shaped substrates joined together by an adhesive layer.

Present day laminating technology in the production of packaging is based on individual layers which are applied by means of rolls. On bonding different materials together such as e.g. aluminium and polypropylene it is necessary, with respect to the type of adhesive film used, to find a compromise between the optimum properties to achieve bonding on the aluminium surface and on the polypropylene surface. To achieve bonding with an adhesive therefore, it is necessary to accept a compromise between the optimum formulation for aluminium and polypropylene. Optimum adhesive layers, therefore, often require expensive formulations. If necessary, to obtain optimum bonding an additional primer must be applied, which either requires a separate pass on the machine or an additional station for its application.

For many years now, a liquid film coating process, known under the name of “Curtain Coating”, has been employed for the production of multi-layer photographic films and papers. In this coating process several layers coming from a slit-shaped nozzle form a free-falling curtain and are applied simultaneously to a moving strip of material.

It has also been proposed to use curtain coating technology for coating paper and for manufacturing plastic laminate types of material.

In WO-A-0154828 a process for manufacturing a multi-layer packaging laminate with at least two superimposed layers is made known in which process two or more layers are deposited in a liquid form onto a substrate made of paper, cardboard or plastic film, which may if desired already be coated, and subsequently dried. Thee liquid film coatings are adhesive layers, barrier layers, intermediate layers as spacers, oxygen-scavenger layers and hot-sealing layers.

Known from U.S. Pat. No. 6,845,599 is a liquid coating process which is an alternative to curtain coating and is known by the name “Slide Coating”. In that coating process several layers are simultaneously applied from a nozzle slide surface directly onto a substrate which is passed directly over a run-off edge of the nozzle.

The object of the invention is to provide a process of the kind mentioned at the start by means of which different substrates can be adhesively bonded in a simple and cost favourable manner.

That objective is achieved by way of the invention in that a first substrate is coated, via liquid film coating using curtain coating or slide coating, with a liquid film comprising at least two adhesive layers and subsequently bonded to the second substrate.

Each adhesive layer is functionally optimised for the respective neighbouring substrate.

By the term “functionally optimised” is to be understood that the formulations used to make the adhesives are individually adapted with respect to chemical composition and/or physical properties to suit the substrates bordering the adhesive layers, with the resut that optimum adhesive bonding is achieved between each pair substrate/neighbouring adhesive layer.

Using the process according to the invention it is possible, in a simple manner, to coat two substrates that have different surface properties with adhesives each of which provides optimum adhesion for the specific substrate.

The adhesive formulations which are optimised with respect to a specific substrate are often expensive products. Preferably therefore, use is made of a liquid film which features two adhesive layers and an intermediate layer situated between the adhesive layers, whereby the thickness of the adhesive layer is less than the thickness of the intermediate layer. The thickness of the adhesive layers is usefully about 1 to 30%, preferably 1 to 10% of the thickness of the intermediate layer.

The intermediate layer comprises preferably of a cost favourable material such as e.g. a urethane based adhesive, in particular a standard urethane adhesive such as e.g. aromatic or aliphatic isocyanates.

The adhesive layers may e.g. be of plastics that are urethane based e.g. polyether, polyester, or polybutadienpolyolemers, acrylic or epoxy based or combinations of these adhesives.

The layers of liquid film may be solvent-based, solvent-free or water-based. Solvent-free coating fluids are preferred as with these the normal drying step is omitted.

Substrate materials that may be employed are plastic films such as e.g. polyethylene-terephthalate (PET), polyethylene (PE), polypropylene (PP), polyamide (PA), metal foils such as e.g. aluminium foils, if desired coated with a barrier layer e.g. of SiOₓ, paper or a combination of at least two of the above materials.

Further advantages, features and details of the invention are revealed in the following description of preferred exemplified embodiments and with the aid of the drawing which shows schematically in

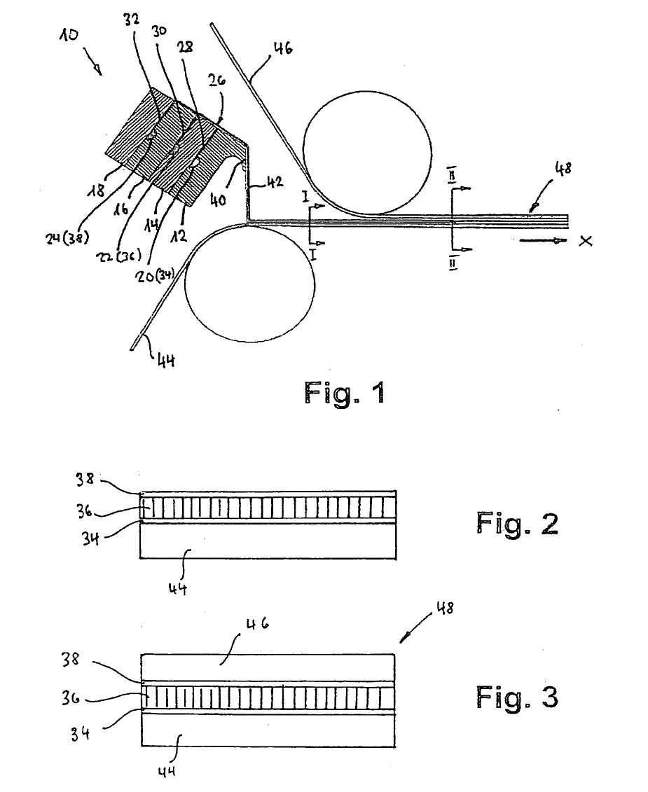

FIG. 1 in cross-section, the sequence of the process of joining two substrates using curtain coating

FIG. 2 a cross-section through a detail in FIG. 1 along line I-I;

FIG. 3 a cross-section through a detail in FIG. 1 along line II-II;

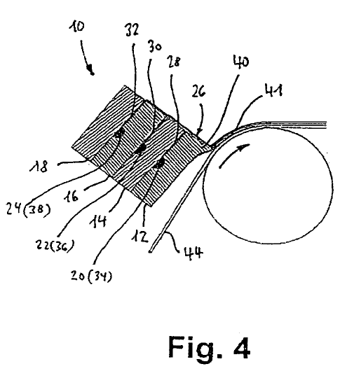

FIG. 4 cross-sectional view of the slide coating process which is an alternative to the curtain coating process shown in FIG. 1.

A nozzle arrangement 10 of a sliding-face coating facility—not shown in detail here—for liquid film coating using the curtain coating method shown in FIG. 1 features four modules 12, 14, 16, 18 that lie one on top of each other. Together, the modules 12, 14, 16, 18 which are arranged in a row together form three distribution chambers 20, 22, 24 arranged perpendicular to the direction of strip movement x, each of the said chambers featuring an outlet slit 28, 30, 32 ending in a nozzle sliding surface 26. The distribution chambers 20, 22, 24 are separately fed coating fluids 34 (adhesive), 36 (intermediate layer, 38 (adhesive) in dosed amounts according to the amount required at the nozzle sliding surface 26.

The coating fluids 34, 36, 38 emerging from the distribution chambers 20, 22, 24 via the outlet slits 28, 30, 32 forming layers of superimposed fluids 34, 36, 38 run as three-layer liquid film over a run-off edge 40 on module 12 and form a free-falling curtain 42.

The three-layer curtain 42 made up of the coating fluids 34, 36, 38 meet essentially in a perpendicular manner a first substrate strip 44 moving in the direction x and forms the fluid coating on its surface as shown in FIG. 2.

A second substrate strip 46 is fed in direction x to the first substrate 44 coated with the coating fluids 34, 36, 38, and bonded to the coated first strip 44 to form a laminate 48 shown in FIG. 3.

Using the process shown in FIG. 1 a laminate e.g. made up of an aluminium foil and a PET film can be produced as follows. An aluminium foil is coated with a three-layer liquid film, then the coated aluminium foil adhesively bonded to a PET film. The three-layer liquid film comprises a first adhesive layer optimised with respect to the aluminium a middle layer of a standard urethane adhesive and a second urethane acrylic or epoxy-based adhesive layer optimised with respect to the PET surface. The thickness of the two outer lying adhesive layers amounts to approximately 10% of the thickness of the middle layer.

FIG. 4 shows a nozzle arrangement 10 having essentially the same make up as the nozzle arrangement in FIG. 1, whereby the run-off surface 40 is modified to carry out the slide-coating process. Here, the three-layer liquid film 41 slides from the run-off edge 40 directly onto the substrate strip 44 passing the run-off edge 40.

1. A process for manufacturing a laminate (48) out of two film-shaped substrates (44, 46) joined together by an adhesive layer, comprising coating the first substrate (44) via curtain coating or slide coating with a multi-layer liquid film comprising at least two adhesive layers (34, 38), and subsequently bonding the first substrate (44) to the second substrate (46) by means one of the at least two adhesive layers (34, 38).

2. The process according to claim 1, wherein each of the adhesive layers (34, 38) is optimized with respect to function to suit surface of the neighboring substrate (44, 46).

3. The process according to claim 2, wherein the liquid film features the two adhesive layers (34, 38) and an intermediate layer (36) situated between the adhesive layers (34, 38).

4. The process according to claim 3, wherein the thickness of adhesive layers (34, 38) is less than thickness of the intermediate layer (36).

5. The process according to claim 4, wherein the thickness of the adhesive layers (34, 38) is 1 to 30 percent of the thickness of the intermediate layer (36).

6. The process according to claim 5, wherein the adhesive layers (34, 38) are made up of adhesives that are urethane based.

7. The process according to claim 3, wherein the intermediate layer (36) is made of a urethane-based adhesive.

8. The process according to claim 7, wherein the layers (34, 36, 38) of liquid film are solvent-based, solvent-free or water-based.

9. The process according to claim 8, wherein the substrates (44, 46) are plastic films, metal foils, paper or a combination of at least two of these materials.

10. The process according to claim 1, wherein the liquid film features the two adhesive layers (34, 38) and an intermediate layer (36) situated between the adhesive layers (34, 38).

11. The process according to claim 10, wherein thickness of the adhesive layers (34, 38) is less than thickness of the intermediate layer (36).

12. The process according to claim 10, wherein the thickness of adhesive layers (34, 38) is 1 to 30 percent of the thickness of the intermediate layer (36).

13. The process according to claim 10, wherein the thickness of the adhesive layers (34, 38) is 1 to 10 percent of the thickness of the intermediate layer (36).

14. The process according to claim 5, wherein the thickness of the adhesive layers (34, 38) is 1 to 10 percent of the thickness of the intermediate layer (36).

15. The process according to claim 1, wherein adhesive layers (34, 38) are made up of adhesives that are urethane-based.

16. The process according to claim 1, wherein the adhesive layers (34, 38) are made up of adhesives that are urethane-based selected from the group consisting of polyethers, polyesters, or polybutadiene polyols, acrylic or epoxy based or combinations of the mentioned adhesives.

17. The process according to claim 15, wherein the adhesive layers (34, 38) are made up of adhesives that are urethane based selected from the group consisting of polyethers, polyesters or polybutadiene polyols, acrylic or epoxy based or combinations of the mentioned adhesives.

18. The process according to claim 1, wherein the intermediate layer (36) is made up of a urethane-based adhesive.

19. The process according to claim 1, wherein the intermediate layer (36) is made of a urethane-based adhesive, with aromatic or aliphatic isocyanates.

20. The process according to claim 1, wherein the layers (34, 36, 38) of liquid film are solvent-based, solvent-free or water-based.

21. The process according to claim 1, wherein the substrates (44, 46) are plastic films, metal foils, paper or a combination of at least two of these materials.
